(19) United States
(12) Patent Application Publication
(10) Pub. No.: US 2010/0141704 A1
(43) Pub. Date: Jun. 10, 2010

(54) IMAGE FORMING APPARATUS

(75) Inventor: Jee Hoon CHUN, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/556,637

(22) Filed: Sep. 10, 2009

(30) Foreign Application Priority Data
Dec. 9, 2008 (KR) 10-2008-124392

(51) Int. Cl. B41J 2/165

(52) U.S. Cl. 347/22

(57) ABSTRACT

An image forming apparatus a plurality of head chip modules including a plurality of head chips, and a plurality of sub covers to cover the plurality of head chip modules individually. Covering the plurality of head chip modules respectively with a plurality of sub covers a significant reduction in evaporation of ink from nozzle parts of the head chips.

### CROSS-REFERENCE TO RELATED APPLICATIONS

This application claims priority under 35 U.S.C. §119(a) of Korean Patent Application No. 2008-0124392, filed on Dec. 9, 2008 in the Korean Intellectual Property Office, the disclosure of which is incorporated herein by reference.

### BACKGROUND

1. Field of the Invention

The present general inventive concept relates to an image forming apparatus, and more particularly, to an array type image forming apparatus having a nozzle part of a length corresponding to a width of a printing medium.

2. Description of the Related Art

Image forming apparatuses are devised to form a black-and-white image or a color image on a printing medium, such as paper, according to print signals. Examples of image forming apparatuses include laser printers, inkjet printers, copiers, facsimiles, and devices combining functions thereof

Of the image forming apparatuses, an inkjet type image forming apparatus is designed to form an image by ejecting liquid-phase ink to a printing medium surface according to print signals. The inkjet type image forming apparatus includes a print head to eject ink according to print signals. As the print head ejects ink droplets according to print signals, an image, such as a letter, figure, etc., is printed on a printing medium.

The print head of the inkjet type image forming apparatus is provided with a plurality of head chips, each of which is provided with a nozzle part for ink ejection. As ink is discharged from the nozzle parts to a printing medium, an image is printed on the printing medium. In the case of the inkjet type image forming apparatus, ink is always present on the nozzle parts of the head chips due to an operating principle of the image forming apparatus.

However, when the image forming apparatus is not used for a long term, there is a risk of the nozzle parts of the head chips getting clogged due to evaporation of the ink present on the nozzle parts.

Therefore, to solve the above-described problem, the inkjet type image forming apparatus is provided with a cover to cover-up the head chips when an image forming operation is not being carried out, the cover serving to prevent evaporation of ink.

Further, it is noted that the plurality of head chips provided in the print head are arranged in a width direction of the printing medium. If the head chips are inevitably installed at slightly different heights due to an operational tolerance when being installed to the print head, some head chips will not come into close contact with the cover, causing air to be introduced into a space between the cover and the head chips. If the introduction of air between the cover and the head chips is continued for a long time, there is a risk of the nozzle parts getting clogged due to evaporation of ink within the nozzle parts of the head chips.

### SUMMARY

Therefore, the present general inventive concept provides an image forming apparatus in which a plurality of head chips provided in a print head uniformly come into close contact with a cover, so as to prevent evaporation of ink in nozzle parts of the head chips when the image forming apparatus is not used for a long time.

Additional features and utilities will be set forth in part in the description which follows and, in part, will be obvious from the description, or may be learned by practice of the present general inventive concept.

In accordance with one feature of the present general inventive concept, the above and/or other features can be achieved by the provision of an image forming apparatus including a plurality of head chip modules including a plurality of head chips, and a plurality of sub covers to cover the plurality of head chip modules individually.

The image forming apparatus may further include a main cover to which the plurality of sub covers may be installed.

The image forming apparatus may further include a plurality of elastic members to elastically support the plurality of sub covers respectively.

Each of the sub covers may include a cover member made of an elastically deformable material, and a supporting plate supported by the elastic member.

The image forming apparatus may further include a supporting member to support the main cover, and each of the elastic members may have one end installed to the supporting member and the other end penetrated through the main cover to thereby be installed to the sub cover.

In accordance with another feature of the present general inventive concept, there may be provided an image forming apparatus including a print head provided with a plurality of head chips, a main cover to cover all of the plurality of head chips, and a plurality of sub covers installed to the main cover and configured to individually cover a part of the plurality of head chips.

In accordance with a further feature of the present general inventive concept, there may be provided an image forming apparatus including a body, a print head installed to the body and provided with a plurality of head chips, and a cover unit including a plurality of sub covers configured to individually cover a part of the plurality of head chips.

The cover unit may further include a main cover to which the plurality of sub covers may be installed.

The cover unit may further include a supporting member to support the main cover, and a pivoting arm having one end rotatably installed to the body and the other end installed to the supporting member.

The cover unit may further include a drive motor to generate a rotating force, a first link to be rotated upon receiving the rotating force of the drive motor, and a second link having one end connected to the first link and the other end connected to the pivoting arm

### BRIEF DESCRIPTION OF THE DRAWINGS

These and/or other features and utilities of exemplary embodiments of the present general inventive concept will become apparent and more readily appreciated from the following description of the embodiments, taken in conjunction with the accompanying drawings, in which:

FIGS. 1 and 2 are perspective views schematically illustrating an image forming apparatus in accordance with an exemplary embodiment of the present general inventive concept;

FIG. 3 is a perspective view of a print head and a cover unit useable with the image forming apparatus in accordance with an exemplary embodiment of the present general inventive concept;

FIG. 4 is a side view illustrating operation of the print head and cover unit useable with the image forming apparatus in accordance with an exemplary embodiment of the present general inventive concept; and

FIG. 5 is an exploded perspective view illustrating an installation configuration of a main cover and a sub cover in accordance with an exemplary embodiment of the present general inventive concept.

### DETAILED DESCRIPTION OF THE PREFERRED EMBODIMENTS

Reference will now be made in detail to an exemplary embodiment of the present general inventive concept, examples of which are illustrated in the accompanying drawings, wherein like reference numerals refer to like elements throughout. The exemplary embodiments are described below to explain the present general inventive concept by referring to the figures.

Hereinafter, an image forming apparatus in accordance with an exemplary embodiment of the present general inventive concept will be described with reference to the accompanying drawings.

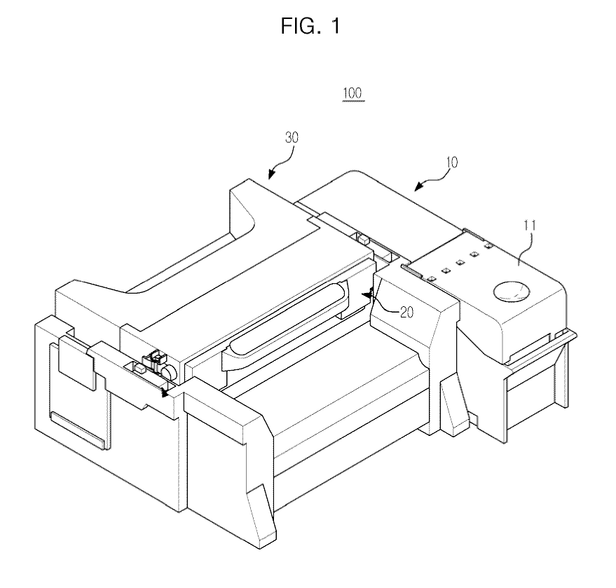

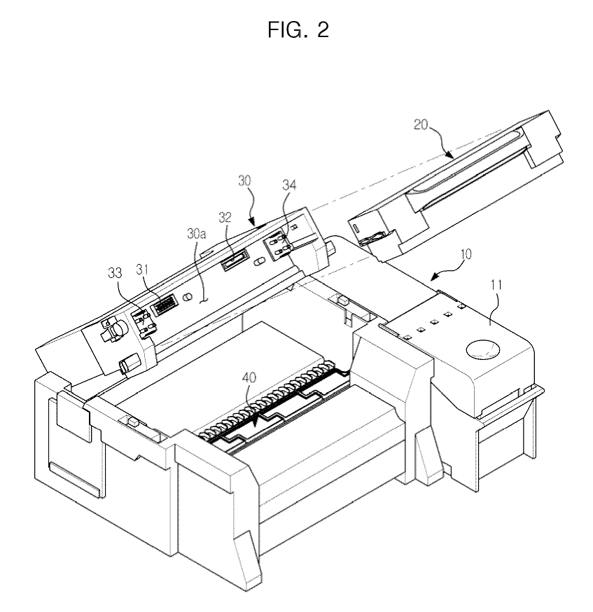

As illustrated in FIGS. 1 and 2, the image forming apparatus 100 in accordance with the present exemplary embodiment may include a body 10, and a print head 20 provided separately from the body 10 and detachably mounted to the body 10 to allow exchange thereof as necessary. A cradle 30 may be provided on the body 10. The cradle 30 may be defined with a head mount 30a, into which the print head 20 is inserted. The cradle 30 may be pivotally rotatably mounted on the body 10, to allow the print head 20 to be easily detachable from the body 10 via rotation of the cradle 30.

The body 10 may contain, for example, a variety of rollers (not illustrated) to deliver a printing medium, a variety of motors (not illustrated) to operate the rollers, a power supply device (not illustrated) to supply power, a maintenance device (not illustrated) to manage efficient ejection of ink from the print head 20, a control device (not illustrated) to control general operations of the image forming apparatus 100, an ink tank 11 in which different colors of inks (i.e., magenta, cyan, and yellow inks) may be stored respectively, and a regulator (not illustrated) arranged between the ink tank 11 and the print head 20 and adapted to apply a negative pressure to ink so as to allow an appropriate amount of ink to be fed into the print head 20 only when the print head 20 ejects ink. The above-mentioned constituent elements may be typical elements of the inkjet type image forming apparatus 100 and thus, a detailed description thereof will be omitted.

The head mount 30a, defined in the cradle 30, may be provided with a variety of connection terminals 31 and 32 for transmission of power and electric signals, couplers 33 and 34 for transmission of ink into the print head 20, and the like. As the print head 20 is mounted in the head mount 30a, accordingly, the supply of power, electric signals, and ink can be accomplished.

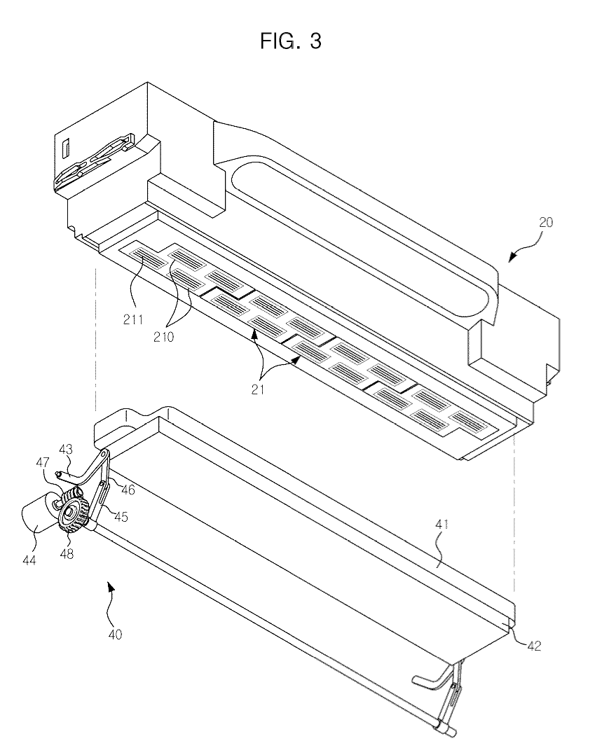

The print head 20, as illustrated in FIG. 3, may be an array type print head having nozzle parts 211, a length of the nozzle parts 211 being at least greater than a width of a printable printing medium. In the print head 20 of an exemplary embodiment of the present general inventive concept, a plurality of head chips 210, each of which may include the nozzle part 211, may be arranged in rows in the print head 20, such that the nozzle parts 211 provided in the plurality of head chips 210 have a length substantially corresponding to the width of the printing medium. In addition, in the print head 20 of an exemplary embodiment of the present general inventive concept, a predetermined number of the head chips 210 may constitute a single module such that a total of the plurality of head chips 210 may constitute a plurality of head chip modules 21. The plurality of head chip modules 21 may be arranged in a row in a width direction of the printing medium. In this case, the nozzle parts 211 of the head chips 210 provided in the plurality of head chip modules 21 may have a length corresponding to the width of the printing medium.

The body 10, as illustrated in FIG. 3, may be provided with a cover unit 40. The cover unit 40 may cover the print head 20 when the image forming apparatus 100 is not being operated, to prevent evaporation of ink present on the nozzle parts 211 of the head chips 210 arranged in the print head 20.

The cover unit 40 may include a main cover 41 with an angle of rotation A2 to cover all of the plurality of head chip modules 211 arranged in the print head 20, a supporting member 42 to support the main cover 41, a pivoting arm 43 with an angle of rotation A1 and having one end rotatably installed to the body 10 and the other end installed to the supporting member 42 so as to allow the supporting member 42 and the main cover 41 supported on the supporting member 42 to be rotatably installed to the body 10, a drive motor 44 to generate a rotating force, a first link 45 to be rotated by the drive motor 44, a second link 46 having one end connected to the first link 45 and the other end connected to the pivoting arm 43, and speed reduction gears 47 and 48 to reduce the rotating force generated from the drive motor 44 and to transmit the reduced rotating force to the first link 45.

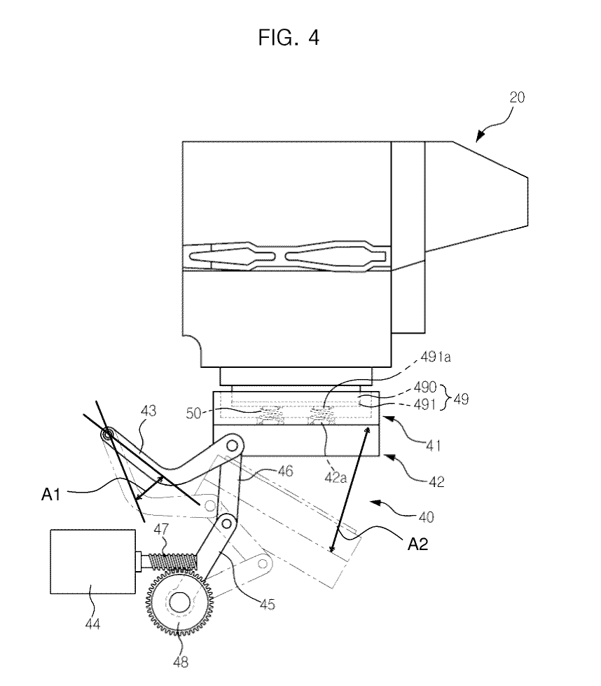

When the image forming apparatus 100 is not being operated, as illustrated in FIG. 4, the cover unit 40 may cover the head chips 210 as the main cover 41 is moved to the print head 20 by rotating the drive motor 44 in one direction. When the image forming apparatus 100 is operated, the drive motor 44 may be rotated in an opposite direction, causing the main cover 41 to be separated from the print head 20 and exposing the head chips 210 to the outside.

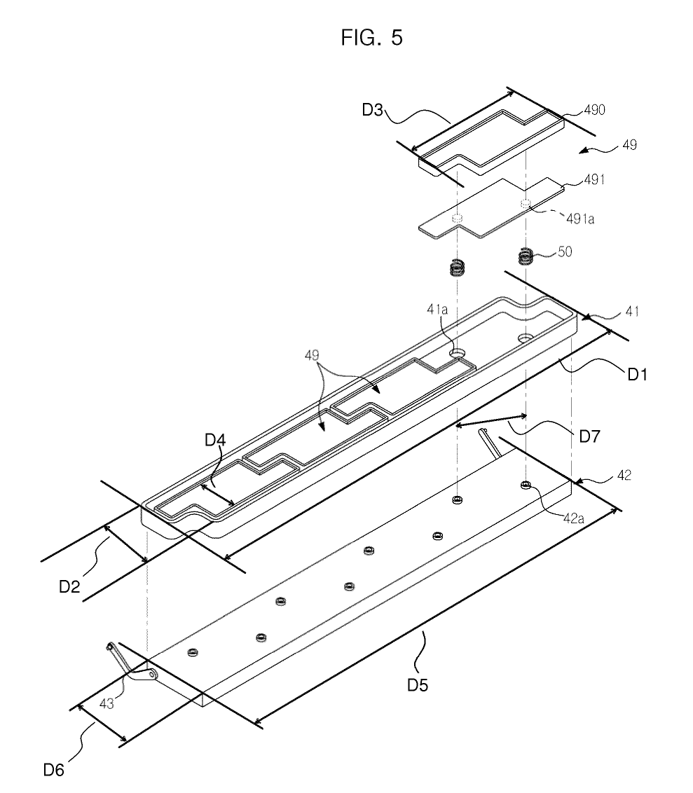

The cover unit 40, as illustrated in FIG. 5, may further include a plurality of sub covers 49 installed to the main cover 41. Each of the sub covers 49 has a shape corresponding to the head chip module 21, such that the sub covers 49 may respectively cover the plurality of head chip modules 21 arranged in the print head 20.

The sub cover 49 may include a cover member 490 made of an elastically deformable material so as to come into close contact with the head chip module 21, and a supporting plate 491 to support the cover member 490. The supporting plate 491 may be elastically supported by elastic members 50, to allow the cover member 490 to come into close contact with the head chip module 21. In an exemplary embodiment of the present general inventive concept, the elastic member 50 may have one end installed to the supporting member 42 and the other end penetrated through a hole 41a of the main cover 41 so as to be installed to the supporting plate 491 of the sub cover 49. The shortest distance between two elastic members 50 is represented as D7 in FIG. 5. The supporting member 42 may be provided with first fixing protrusions 42a, to each of which one end of the elastic member 50 may be interference fitted. The supporting plate 491 may be provided with second fixing protrusions 491a, to each of which the other end of the elastic member 50 may be interference fitted. Here, the elastic member 50 may take the form of a coil spring. As the plurality of elastic members 50 may be provided to support the plurality of sub covers 49 respectively, the plurality of sub covers 49 may be operable individually by the plurality of elastic members 50 and may be independently elastically supported with respect to the plurality of head chip modules 21.

When the plurality of sub covers 49 is operated independently to cover the plurality of head chip modules 21, the plurality of sub covers 49 may be respectively able to come into close contact with the plurality of head chip modules 21. This may significantly reduce a possibility of evaporation of ink caused when the head chips 210 do not come into close contact with the sub covers 49.

The length D1 of the main cover 41 may be similar to the length D5 of the supporting member 42. Also, the width D2 of the main cover 41 may be similar to the width D6 of the supporting member 42. Further, the width D4 of the cover member 490 may be less than or equal to the width D2 of the main cover 41. Finally, the length D3 of a cover member may be less than or equal to the length D1 of the main cover 41.

Furthermore, as the plurality of head chip modules 21 is covered both by the sub covers 49 and the main cover 41 enclosing the sub covers 49, introduction of air into the head chips 210 may be more surely reduced, preventing evaporation of the ink.

Although an exemplary embodiment of the present general inventive concept describes the print head 20 of the image forming apparatus 100 may include the plurality of head chip modules 21 as arranged to be covered with the plurality of sub covers 49 individually on a per module basis, the present general inventive concept is not limited thereto and may be applicable to a print head, which does not employ the plurality of head chip modules 21 such that the plurality of sub covers 49 respectively cover a part of the plurality of head chips 210.

As is apparent from the above description, an exemplary embodiment of the present general inventive concept may provide an image forming apparatus in which a plurality of head chip modules provided in a print head may be individually covered with a plurality of sub-covers, achieving a significant reduction in evaporation of ink from nozzle parts of head chips.

Although a few exemplary embodiments of the present general inventive concept have been illustrated and described, it would be appreciated by those skilled in the art that changes may be made in these embodiments without departing from the principles and spirit of the present general inventive concept, the scope of which is defined in the claims and their equivalents.

What is claimed is:

1. An image forming apparatus comprising:
a plurality of head chip modules including a plurality of head chips; and
a plurality of sub covers to cover the plurality of head chip modules individually.

2. The image forming apparatus according to claim 1, further comprising:
a main cover to which the plurality of sub covers is installed.

3. The image forming apparatus according to claim 2, further comprising:
a plurality of elastic members to elastically support the plurality of sub covers respectively.

4. The image forming apparatus according to claim 3, wherein each of the sub covers includes a cover member made of an elastically deformable material, and a supporting plate supported by the elastic member.

5. The image forming apparatus according to claim 3, further comprising a supporting member to support the main cover,
wherein each of the elastic members has one end installed to the supporting member and the other end penetrated through the main cover to thereby be installed to the sub cover.

6. An image forming apparatus comprising:
a print head provided with a plurality of head chips;
a main cover to cover all of the plurality of head chips; and
a plurality of sub covers installed to the main cover and configured to individually cover a part of the plurality of head chips.

7. The image forming apparatus according to claim 6, further comprising:
a plurality of elastic members to elastically support the plurality of sub covers, respectively.

8. The image forming apparatus according to claim 7, wherein each of the sub covers includes a cover member made of an elastically deformable material, and a supporting plate supported by the elastic member.

9. The image forming apparatus according to claim 7, further comprising:
a supporting member to support the main cover,
wherein each of the elastic members has one end installed to the supporting member and the other end penetrated through the main cover to thereby be installed to the sub cover.

10. The image forming apparatus according to claim 9, further comprising:
a first fixing protrusion protruding from the sub-cover, to which the other end of the elastic member is interference fitted; and
a second fixing protrusion protruding from the supporting member, to which one end of the elastic member is interference fitted.

11. An image forming apparatus comprising:
a body;
a print head installed to the body and provided with a plurality of head chips; and
a cover unit including a plurality of sub covers configured to individually cover a part of the plurality of head chips.

12. The image forming apparatus according to claim 11, wherein the cover unit further comprising:
a main cover to which the plurality of sub covers is installed.

13. The image forming apparatus according to claim 12, wherein the cover unit further includes a supporting member to support the main cover, and a pivoting arm having one end rotatably installed to the body and the other end installed to the supporting member.

14. The image forming apparatus according to claim 13, wherein the cover unit further includes a drive motor to generate a rotating force, a first link to be rotated upon receiving the rotating force of the drive motor, and a second link having one end connected to the first link and the other end connected to the pivoting arm.

15. The image forming apparatus according to claim 12, further comprising:
a plurality of elastic members to elastically support the plurality of sub covers, respectively.

16. The image forming apparatus according to claim 15, wherein each of the elastic members has one end installed to the supporting member and the other end penetrated through the main cover to thereby be installed to the sub cover.

17. The image forming apparatus according to claim 16, wherein each of the sub covers includes a cover member made of an elastically deformable material, and a supporting plate supported by the elastic member.
